(19) United States
(12) Patent Application Publication
(10) Pub. No.: US 2011/0315561 A1
(43) Pub. Date: Dec. 29, 2011

(54) TREATMENT OF SOLUTIONS OR WASTEWATER

(75) Inventors: Korneel P.H.L.A. Rabaey, Wachtebeke (BE); Rene A. Rozendal, Amsterdam (NL)

(73) Assignee: THE UNIVERSITY OF QUEENSLAND, St. Lucia (AU)

(21) Appl. No.: 13/124,511

(22) PCT Filed: Oct. 15, 2009
(86) PCT No.: PCT/AU09/01356

§ 371 Date: Sep. 12, 2011

(30) Foreign Application Priority Data
Oct. 15, 2008 (AU) 2008905338

(51) Int. Cl. C02F 9/14; C02F 1/44; C02F 3/28; C25B 15/00; C02F 1/66; C02F 1/46; C02F 103/32; C02F 101/10; C02F 101/30; C02F 103/08; C02F 103/28

(52) U.S. Cl. 205/615; 210/631; 210/605

(57) ABSTRACT

A method for treating a wastewater stream containing organic material or inorganic material comprising passing the wastewater stream to an anode or a cathode of a bioelectrochemical system to thereby alter the pH of the wastewater stream to: a) reduce the pH of the stream passed to the anode to minimise or suppress precipitation of dissolved cations; or b) increase the pH of the stream passed to the cathode to produce an alkaline stream; or c) reduce the pH of the stream passed to the anode to produce an acid containing stream. In one embodiment, a caustic soda solution is produced at the cathode and recovered for storage and subsequent use.

### FIELD OF THE INVENTION

In one aspect, the present invention relates to a method for treating a wastewater stream. In another aspect, the present invention relates to a method for forming an acidic solution or an alkaline solution.

### BACKGROUND TO THE INVENTION

Many industries require substantial amounts of caustic soda and/or hydrochloric acid for their operations. Caustic soda is typically made via the chloralkali process, in which a NaCl brine is electrolysed. There are 3 main methods used in this regard, being the Mercury cell process (also called the Castner-Kellner process), the Diaphragm cell process and the Membrane cell process. The latter uses a Nafion cation exchange membrane to separate the cathode and anode reactions. Only sodium ions and some water pass through the used membrane.

Hydrochloric acid is produced industrially via two methods. First, during the chloralkali process it is formed at the anode, where chloride is converted to chlorine, which is recombined with hydrogen to HCl: Cl₂+H₂→2HCl. Hydrochloric acid can also be organically synthesized, as a byproduct during production of e.g. Teflon and PVC. Both the caustic soda and the hydrochloric acid are widely used in industry, often to correct the pH of waste streams. For example, the paper and pulp industry uses substantial amounts of hydrochloric acid to prevent calcium scaling, while also caustic soda is used to remove calcium in dedicated reactors.

Bioelectrochemical systems, such as microbial fuel cells and microbial electrolysis cells, are generally regarded as a promising future technology for the production of energy from organic material present in wastewaters. Industrial, agricultural and domestic wastewaters typically contain dissolved organics that require removal before discharge into the environment. Typically, these organic pollutants are removed by aerobic treatment, which can assume to large amounts of electrical energy for aeration.

Recently, bioelectrochemical wastewater treatment has emerged as a potentially interesting technology for the production of energy from wastewaters. Bioelectrochemical wastewater treatment is based on the use of electrochemically active microorganisms, which transfer the electrons to an electrode (anode) while they are oxidising (and thus removing) organic materials in wastewaters. Bioelectrochemical wastewater treatment can be accomplished by electrically coupling a microbial bioanode to a counter electrode (cathode) that performs a reduction reaction. As a result of this electrical connection between the anode and the cathode, the electrode reactions can occur and electrons can flow from the anode to the cathode. The bioelectrochemical system may operate as a fuel cell (in which case electrical energy is produced) or as an electrolysis cell (in which case, electrical energy is fed to the bioelectrochemical system) (Rozendal, R. A., H. V. M. Hamelers, K. Rabaey, J. Keller, and C. J. N. Buisman. 2008. Towards practical implementation of bioelectrochemical wastewater treatment. Trends in Biotechnology 26:450-459).

The anode reaction in bioelectrochemical systems produces protons or consumes hydroxyl ions which can acidify the biofilm surrounding the anode and negatively affect the performance of the bioelectrochemical system. It has been suggested that adding a buffer to the electrolyte or increasing the buffering strength of the electrolyte used in a bioelectrochemical system can result in significant increases in the current density obtained from the bioelectrochemical system (Liu et al Environmental Science and Technology 2008). Accordingly, conventional wisdom tries to avoid the acidification of the electrolyte in the anode compartment of the bioelectrochemical system. In one study a possible bacteriostatic effect at the anode and/or the cathode due to the acidification/alkalinisation was mentioned in the context of reverse osmosis concentrates (Clauwaert and coworkers, Applied Microbiology and Biotechnology 2008).

One possible solution to this problem was proposed in international patent application number WO2008109962, the entire contents of which are incorporated herein by cross reference. In this international patent application, a microbial fuel cell was described in which a wastewater was fed to an anode chamber and subsequently transferred from the anode chamber to the cathode chamber. Acidification of the solution was avoided by virtue of any acidity that may have been formed in the anode chamber being destroyed by the competing reactions in the cathode chamber. The apparatus and method described in international patent application number WO2008109962 provide a very suitable apparatus and method for generating electrical power by treating wastewater streams in a bioelectrochemical system.

Another widespread solution is the omission of the membrane separating anode and cathode (Liu, H., and B. E. Logan. 2004, “Electricity generation using an air-cathode single chamber microbial fuel cell in the presence and absence of a proton exchange membrane”, Environmental Science & Technology 38:4040-4046). This improves mixing between the fluids and results in reduced pH differences between anode and cathode. The systems generally suffer from fuel crossover from anode to cathode.

### BRIEF DESCRIPTION OF THE INVENTION

It is an object of some embodiments of the present invention to provide a method for treating a wastewater stream to produce a wastewater stream having reduced organic content and other desirable characteristics such as decreased salt content or reduced tendency for ions dissolved in the solution to precipitate.

It is an object of some embodiments of the present invention to provide a method for the microbial production of chemicals and/or biochemicals via reductive processes.

It is an object of other embodiments of the present invention to provide a method for forming an acidic solution or alkaline solution.

In a first aspect, the present invention provides a method for treating a wastewater stream containing organic material or an inorganic comprising passing the wastewater stream to an anode or a cathode of a bioelectrochemical system, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, to thereby alter the pH of the wastewater stream to:

a) reduce the pH of the stream passed to the anode to minimise or suppress precipitation of dissolved cations; or

b) increase the pH of the stream passed to the cathode to produce an alkaline stream; or

c) reduce the pH of the stream passed to the anode to produce an acid containing stream.

As will be understood by persons skilled in the art, the bioelectrochemical system used in the present invention will include electrochemically active microorganisms associated with either the anode or the cathode.

In one embodiment of the present invention the bioelectrochemical system comprises an anode chamber and a cathode chamber separated by an ion permeable membrane, as known to the person skilled in the art. Ion permeable membranes suitable for use in the present invention include any ion permeable membranes that may be used in bioelectrochemical systems (Kim et al., Environ. Sci. Technol., 2007, 41, 1004-1009; Rozendal et al., Water Sci. Technol., 2008, 57, 1757-1762). Such ion permeable membranes may include ion exchange membranes, such as cation exchange membranes and anion exchange membranes. Porous membranes, such as microfiltration membranes, ultrafiltration membranes, and nanofiltration membranes, may also be used in the bioelectrochemical system used in the present invention. The ion permeable membrane facilitates the transport of positively and/or negatively charged ions through the membrane, which compensates for the flow of the negatively charged electrons from anode to cathode and thus maintains electroneutrality in the system. Pervaporation membranes and membranes as used for membrane distillation may also be used.

The anode and the cathode are connected to each other by an electrical circuit. In one embodiment, the electrical circuit may comprise a conductor having very low resistance such that in some cases the conductor acts as an electrical short circuit between the anode and the cathode. In another embodiment, a power supply may be included in the electrical circuit. This power supply can be used to apply a voltage on the system, which increases the rate of the electrochemical reactions taking place. The voltage applied with a power supply between the anode and the cathode may be between 0 and 10 V, preferably between 0 and 2 V, more preferably between 0 and 1.0 V. This may result in a volumetric current density in the bioelectrochemical cell of between 0 and 10,000 A/m³ of bioelectrochemical cell, preferably between 10 and 5,000 A/m³ of bioelectrochemical cell, more preferably between 100 and 2500 A/m³ of bioelectrochemical cell and/or an area specific current density of between 0 and 1,000 A/m² membrane surface area, preferably between 1 and 100 A/m² membrane surface area, more preferably between 2 and 25 A/m² membrane surface area.

In various embodiments of the present invention, the following streams or solutions may be fed to the bioelectrochemical system:

i) a wastewater stream may be fed to the anode compartment and a wastewater stream may be fed to the cathode compartment. This will result in the formation of an acidified wastewater stream in the anode compartment and a wastewater stream of increased alkalinity in the cathode compartment. The wastewater stream that is fed to the cathode compartment may be different to the wastewater stream fed to the anode compartment. Alternatively, a single wastewater stream may be split and a part fed to the anode compartment and a part fed to the cathode compartment. In this embodiment, both the anode and the cathode may be biocatalyzed by electrochemically active microorganisms.

ii) a wastewater stream may be fed to the anode compartment and water or an aqueous stream may be fed to the cathode compartment. The aqueous stream fed to the cathode compartment may include cations such as sodium, potassium, magnesium or calcium cations. In this embodiment, the product stream leaving the cathode compartment may comprise an alkaline stream having a high pH. In this embodiment, the anode may be biocatalyzed by electrochemically active microorganisms. The cathode may comprise a conventional cathode.

iii) a wastewater stream may be fed to the cathode compartment and water or an aqueous solution may be fed to the anode compartment. The aqueous stream fed to the anode compartment may include anions such as chloride, nitrates, phosphates, carbonate or acetate. In this embodiment, the product stream leaving the anode compartment may comprise an acidified stream having a low pH. In this embodiment, the cathode may be biocatalyzed by electrochemically active microorganisms. The anode may comprise a conventional anode.

iv) water or an aqueous solution may be fed both to the anode and the cathode.

In one embodiment of the first aspect of the present invention, the wastewater stream is passed to the anode of the bioelectrochemical system. This will result in oxidation of the organic material in the wastewater stream, which acts to reduce the quantity or concentration of the organics in the wastewater stream. Protons (H⁺ions) are also formed and these result in a decrease in the pH of the wastewater stream. Suitably, this embodiment is operated such that the pH of the wastewater stream decreases to a level at which precipitation of cations (particularly calcium ions or magnesium ions or struvite ions) or precipitation reactions is minimised or suppressed. It will be appreciated that many wastewater streams contain dissolved cations and these dissolved cations are prone to precipitate if the pH of the wastewater stream increases, as many cations form carbonate and/or hydroxide precipitates if pH values increase above a threshold value. This value is somewhat dependent upon the composition of the liquid solution. Generally, carbonate and/or hydroxide precipitates, particularly calcium carbonate, are likely to form if the pH of the solution increases above 6.5. In other cases, if the pH increases above a threshold level, precipitation reactions may occur to cause the precipitation of more complex precipitates, such as struvite. Precipitation, such as the precipitation of carbonates and/or hydroxides from wastewater streams can result in the formation of significant scale on process piping and vessels. As will be appreciated by a person skilled in the art, the formation of scale can result in a number of deleterious outcomes on process vessels and processes, including the requirement to completely shut down process vessels for scale removal. Indeed, it is possible that scale may build up in process vessels to an extent that is sufficiently large to render a process vessel inoperative. This can have extremely serious consequences. For example, if a process vessel is used in a water treatment process and that process vessel has to be taken offline, it may become necessary to discharge effectively untreated wastewater. This can have adverse environmental consequences, risk the operator of the plant breaching its operating licences and also result in the operator of the plant having to pay enhanced disposal costs for disposing of the wastewater stream.

In one embodiment, the wastewater stream is treated such that the pH decreases to 7 or below.

In this embodiment of the present invention, a separate wastewater stream may be provided to the cathode of the bioelectrochemical system. Alternatively, a different stream may be provided to the cathode. For example, relatively clean water may be provided to the cathode or a salt solution, reverse osmosis concentrate or brine may be provided to the cathode.

In embodiments of the present invention, where the activity of the electrochemically active microorganisms at the anode results in acidification of the wastewater stream fed to the anode, the pH is unlikely to decrease below about 5 to 5.5, because if the pH decreases below that level, the bacterial activity stops.

In another embodiment, the method of the present invention is operated so that the pH of the stream that is passed to the cathode increases such that an alkaline stream is produced. This alkaline stream may be recovered from the cathode and subsequently used for other purposes. This embodiment corresponds to (b) above.

In one embodiment of this aspect of the present invention, the cathode is biocatalyzed by electrochemically active microorganisms and the biological activity of the electrochemically active microorganisms at the cathode results in the increase in pH of the stream supplied to the cathode. In such embodiments, the pH of the stream fed to the cathode is unlikely to extend above 8 to 8.5, as the biological activity of the microorganisms is likely to stop if the pH exceeds that level. This particular embodiment is useful for producing an alkaline effluent leaving the cathode in which the pH has been adjusted to obtain a desirable downstream processing characteristics.

In one embodiment, the alkaline stream that is produced at the cathode may contain caustic soda (NaOH) or potassium hydroxide (KOH), or indeed any other hydroxide containing solution that may be used for other purposes. Desirably, the alkaline stream that is produced on the cathode contains a dissolved hydroxide salt. This may be achieved by providing a bioelectrochemical system that has an ion permeable membrane separating the anode and cathode, which ion permeable membrane selectively allows cations to pass therethrough.

In some embodiments, the ion permeable membrane may allow cations to pass therethrough but limit the flow of anions therethrough. In this manner, only a fraction of the charge balance is restored by protons, thereby ensuring that the pH of the liquid at the cathode increases. Such cation exchange membranes are known to the person skilled in the art and include membranes such as CMI-7000 (Membranes International), Neosepta CMX (ASTOM Corporation), fumasep® FKB (Fumatech), and Nafion (DuPont). In some embodiments, the ion selective membrane may comprise a cation selective membrane that selectively allows monovalent cations to pass therethrough. In this embodiment, the hydroxide salt present in the cathode solution is likely to be a monovalent cation containing hydroxide salt. Examples may include sodium hydroxide and potassium hydroxide. As in this embodiment the passage of divalent cations through the membrane is limited, the possibility of e.g. calcium carbonates being precipitated on the cathode side of the bioelectrical system may also be reduced.

In one particular embodiment, a wastewater stream is passed to the anode and an aqueous stream or water is passed to the cathode. The wastewater stream may contain dissolved sodium and/or potassium, and/or other cations, which pass through the ion selective membrane between the anode and the cathode to thereby form sodium hydroxide and/or potassium hydroxide in the aqueous solution on the cathode side of the bioelectrochemical system.

In another embodiment, the aqueous stream that is passed to the cathode may contain dissolved cations such as sodium, potassium, calcium, magnesium. For example, the aqueous stream passed to the cathode may comprise a salt solution or a brine or seawater.

In this embodiment, the process may be operated such that the pH of the alkaline stream leaving the cathode is in excess of 10, more preferably great and 12, even more preferably greater than 13. The alkaline stream may be recovered for storage or for transfer for use in other purposes. For example, the alkaline stream may be used in the cleaning of containers or pipes or process vessels used in the food processing industries or in the beverage or bottling industries. One example of use of the present invention is to produce an alkaline stream that is used to clean fermenter tanks in a beer bottling plant or brewery.

In a further embodiment of the present invention, the method is operated such that the pH of the stream that is passed to the anode is reduced to produce an acid containing stream. This embodiment corresponds to (c) above. Suitably, the pH is reduced to below 4, more preferably to below 2, even more preferably to below 1. The acid containing stream is suitably recovered for storage or for use in other purposes.

In this embodiment, the stream that is supplied to the anode may be water or an aqueous stream, such as a solution containing dissolved salts, brine, a reverse osmosis concentrate solution or seawater. The water or aqueous solution supplied to the anode in this embodiment may contain anions, such as chloride, nitrate, phosphate, carbonate, acetate, or mixtures of two or more thereof.

In embodiments of the present invention where an acidified stream of low pH is formed in the anode compartment, the bioelectrochemical system may include a membrane that is selectively permeable to anions. Such anion exchange membranes are known to the person skilled in the art and include membranes such as AMI-7001 (Membranes International), Neosepta AMX (ASTOM Corporation), and fumasep FAA® (fumatech).

In a second aspect, the present invention provides a method for forming an acidic solution or an alkaline solution comprising the steps of providing a bioelectrochemical system having an anode and a cathode, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, feeding an aqueous stream to the anode, feeding an aqueous stream to the cathode, generating an acidic solution at the anode or generating an alkaline solution at the cathode, and recovering the acidic solution or the alkaline solution.

The recovered acidic solution or alkaline solution may be sent to storage. Alternatively, the recovered acidic solution or alkaline solution may be transferred for use in another process. The acidic solution or the alkaline solution may be directly transferred from the bioelectrochemical system to another process without any intervening storage. Alternatively, the acidic solution or the alkaline solution may be transferred to storage prior to being used for other purposes.

In one embodiment, the aqueous stream entering the anode is wastewater from a paper factory or paper recycling plant or paper and pulp plant containing calcium ions. The wastewater is acidified in the anode. In the cathode an alkaline solution is generated. This alkaline solution can be added to the wastewater to precipitate calcium ions.

In one embodiment of the above process, the wastewater has gone through an anaerobic digester. The effluent of the anaerobic digester goes through the anode. At the cathode an alkaline stream is generated.

In a preferred embodiment, the wastewater coming from the anaerobic digester goes through a reactor vessel, in which calcium ions are precipitated. The effluent of the reactor vessel goes to the anode where it is acidified. Part or all of the effluent of the anode goes directly or indirectly back to the anaerobic digester. In the cathode an alkaline stream is generated which is transported to the reactor vessel in which calcium ions are precipitated.

In another embodiment the cathodic fluid becomes alkaline while simultaneously peroxide is generated at the cathode, as a result of the reduction of oxygen or hydroxyl ions. This product can be transported for use elsewhere.

In another embodiment wastewater from a brewing or brewery tank cleaning process is used as influent for the anodic compartment, while at the cathode an alkaline solution is created. The effluent of the anode may be sent to an anaerobic digester. In a variation of this embodiment, reverse osmosis concentrate, a salt solution or a brine can be used as fluid for the cathode compartment or can be added to the anodic influent to provide cations.

In all aspects of the present invention, it is preferred that the electrolyte stream leaving the anode not be sent to the cathode (and vice versa). The exception is where a membrane that only allows particulates smaller than 1 millimeter, preferable smaller than 0.1 mm, even more preferable smaller than 1 micrometer to pass, is placed between the anode and the cathode allowing flow of part or all of the fluid from the anode to the cathode through the membrane (and vice versa).

In some embodiments of the present invention, the anode and cathode are separated by a membrane allowing ion transport, preferably a cation or an anion exchange membrane, a monovalent cation or anion exchange membrane, or any separator allowing the passage of ions.

In some embodiments of the present invention, the cathode material may be selected from the group comprising carbon based materials, graphite, carbon fiber, stainless steel, steel, iron, or any material that allows reduction of oxygen, water or compounds present in the fluid supplied to the cathode.

In some embodiments of the present invention, the anode material may be selected from the group comprising carbon based materials, graphite, carbon fiber, stainless steel, or any material that allows the oxidation of water, organic material (with or without micro-organisms present), chloride, or compounds as present in the fluid supplied to the anode.

In some embodiments of the present invention, the fluid flow through the anode and/or cathode may be perpendicular to the membrane. This can be achieved, for example, by sending fluid through the membrane or by introducing a space or spacer between the membrane and the anodic and/or cathode electrode. Such a spacer is known to a person skilled in the art.

In some embodiments of the present invention, the fluid supplied to the anode may comprise fermented liquid or liquid containing fatty acids and/or alcohols such as acetic acid, propionic acid, butyric acid, methanol, ethanol and others as known to a person skilled in the art. The acidified effluent of the anode may be brought over a stripping column or a membrane exchange unit, or a gas flow may be sent through the fluid in order to recover the fatty acids and/or alcohols. Alternatively the fatty acids and/or alcohols go through the membrane from the anode to the cathode, and are dissolved in the alkaline cathode solution. In some embodiments the membrane will be a pervaporation membrane.

In a preferred embodiment of the above the fatty acid and/or alcohols concentration in the cathode fluid is above 1 gram per liter, more preferably above 5 gram per liter, most preferably above 50 gram per liter.

In some embodiments of the present invention, a volumetric current density in the bioelectrochemical cell of between 0 and 10,000 A/m³ bio-electrochemical system, preferably between 10 and 5,000 A/m³, more preferably between 100 and 2500 A/m³ and/or an area specific current density of between 0 and 1,000 A/m² membrane surface area, preferably between 1 and 100 A/m² membrane surface area, more preferably between 2 and 25 A/m² membrane surface area, may be obtained.

Electrical power may be harvested from or supplied to the bio-electrochemical system at power densities of 0 to 10 kilowatt per m³ bio-electrochemical system.

In another embodiment the fluid entering the cathode may be acid mine drainage or an acidic solution containing dissolved metals. The cathode fluid may increase in pH by either electrochemical or bio-electrochemical reduction of electron acceptors such as water, oxygen, sulfate and others as present in the acid solution or as known to a person skilled in the art.

In a preferred embodiment of the above the pH in the cathode is increased to a level where the metal ions precipitate from the fluid. Examples are metal sulfides or metal hydroxides. The metal ions may precipitate after the cathode fluid has left the cathode compartment, for example, precipitation may take place in a precipitation vessel.

In another embodiment of the above the anode flow is a fluid containing organic material, or a fluid containing electron donors such as water or sulfide and others as known to a person skilled in the art.

In yet another embodiment of the above the reducing power for the cathode is delivered or enhanced by a solar panel or by another means of generating electrical power.

In another embodiment the anode does not have an inlet, rather is submerged in fluid containing electron donor. The anode can be at least partially surrounding a membrane, containing the cathode.

Similarly, in some embodiments, the cathode does not have an inlet rather is submerged in fluid containing electron acceptor. The cathode can be at least partially surrounding a membrane containing the anode.

In a further aspect, the present invention provides a method for treating a wastewater stream containing organic and/or inorganic material comprising passing the wastewater stream to an anode or a cathode of a bioelectrochemical system, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, to thereby:

a) reduce the pH of the stream passed to the anode to minimise or suppress precipitation of dissolved cations; or

b) increase the pH of the stream passed to the cathode to produce an alkaline stream; or

c) reduce the pH of the stream passed to the anode to produce an acid containing stream.

In a further aspect, the present invention provides a method for producing an alkaline aqueous stream comprising the steps of:

providing a bioelectrochemical system comprising an anode compartment having a biocatalysed anode and a cathode compartment having a cathode, the anode compartment and the cathode compartment being separated by an ion permeable membrane, the anode and the cathode being electrically connected to each other;

feeding a wastewater stream to the anode compartment such that organic material and/or inorganic material in the wastewater stream is oxidised;

feeding an aqueous stream to the cathode compartment,

wherein the ion permeable membrane allows cations to pass therethrough but limits the flow of anions therethrough and wherein an alkaline stream is generated in the cathode compartment, and

removing the alkaline aqueous stream from the cathode compartment.

### BRIEF DESCRIPTION OF THE DRAWINGS

FIG. 1 shows a process flow sheet showing the general arrangement of a bioelectrochemical cell suitable for use in the present invention;

FIG. 2 shows a process flow sheet of an embodiment of the present invention in which partial flow of fluid through the membrane can occur;

FIG. 3 shows a process flow sheet in which an embodiment of the present invention is integrated into a pulp and paper processing plant;

FIG. 4 shows a process flow sheet of an embodiment of the present invention in which a bioelectrochemical system is integrated with an anaerobic digetser and a precipitation vessel;

FIG. 5 shows a graph of current vs time for laboratory run 1;

FIG. 6 shows a graph of current vs time for laboratory run 2; and

FIG. 7 shows a graph of current vs time for the brewery run.

### DETAILED DESCRIPTION OF THE DRAWINGS

It will be understood that the drawings have been provided for the purpose of illustrating preferred embodiments of the present invention. Therefore, it will be appreciated that the present invention should not be considered to be limited to the features as shown in the drawings.

Each of the figures have a number of features in common and, for convenience, like reference numerals will be used to describe similar features in each of the figures.

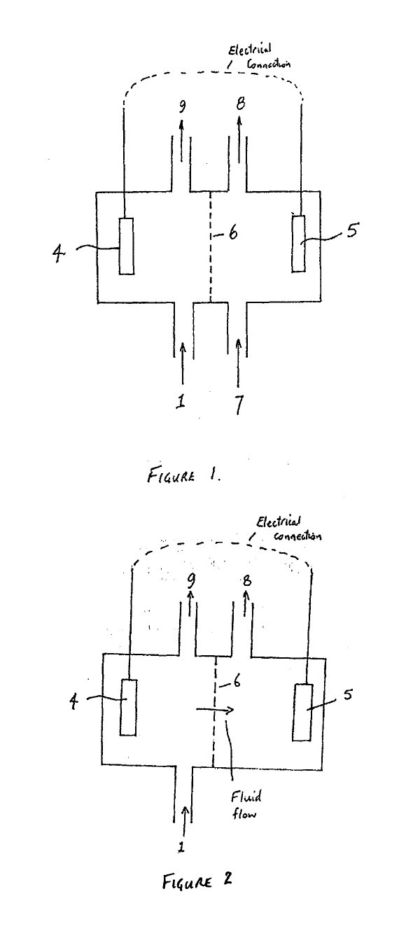

Turning to FIG. 1, which shows a process flow sheet showing the general arrangement of a bioelectrochemical cell suitable for use in the present invention, it can be seen that the apparatus shown in FIG. 1 includes a cathode 4 located within a cathode chamber and an anode 5 located within an anode chamber. A membrane 6, which is permeable to ions, is positioned between the cathode chamber and the anode chamber. As will be known to persons skilled in the art, the anode 5 and the cathode 4 are electrically connected to each other.

The cathode chamber includes a fluid inlet 1 and a fluid outlet 9. The anode chamber includes a fluid inlet 7 and a fluid outlet 8.

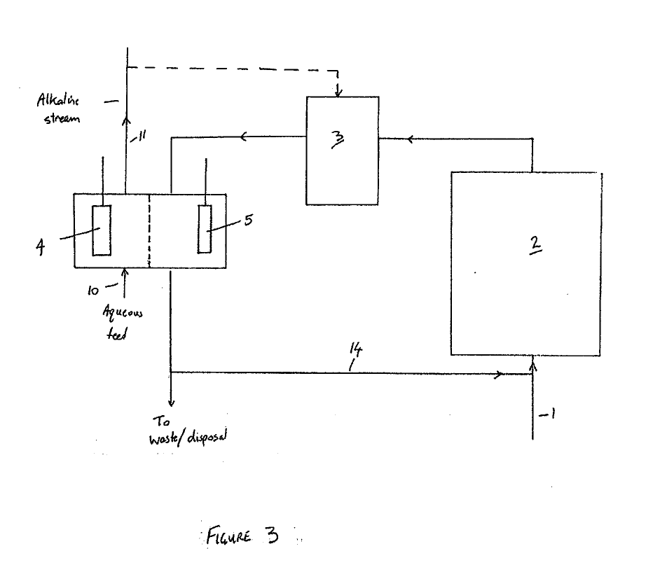

The embodiments shown in FIG. 2 is generally similar to that shown in FIG. 1, except that a partial flow of fluid is permitted through the membrane 6. Therefore, it is possible to not have a fluid inlet to the anode compartment.

In one embodiment of the invention shown in FIGS. 1 and 2, a wastewater stream is fed to the cathode inlet 1. In this embodiment, the cathode 4 is a biocatalyzed cathode. The cathode for may be, for example, a carbon or graphite cathode. A water or aqueous stream may be fed to the anode inlet 7. In this embodiment, an acidified stream 8 is removed from the anode compartment. The acidified stream may have a pH of less than 1.

In another embodiment of the present invention, a wastewater stream is fed to the anode inlet 7 and water or an aqueous stream is fed to the cathode inlet 1. In this embodiment, the anode 5 comprises a biocatalyzed anode. An acidified wastewater stream is removed from the anode outlet 8 and a caustic stream is removed from the cathode outlet 9. The caustic stream may be recovered for subsequent use or storage. The caustic stream may have a pH of greater than 13.

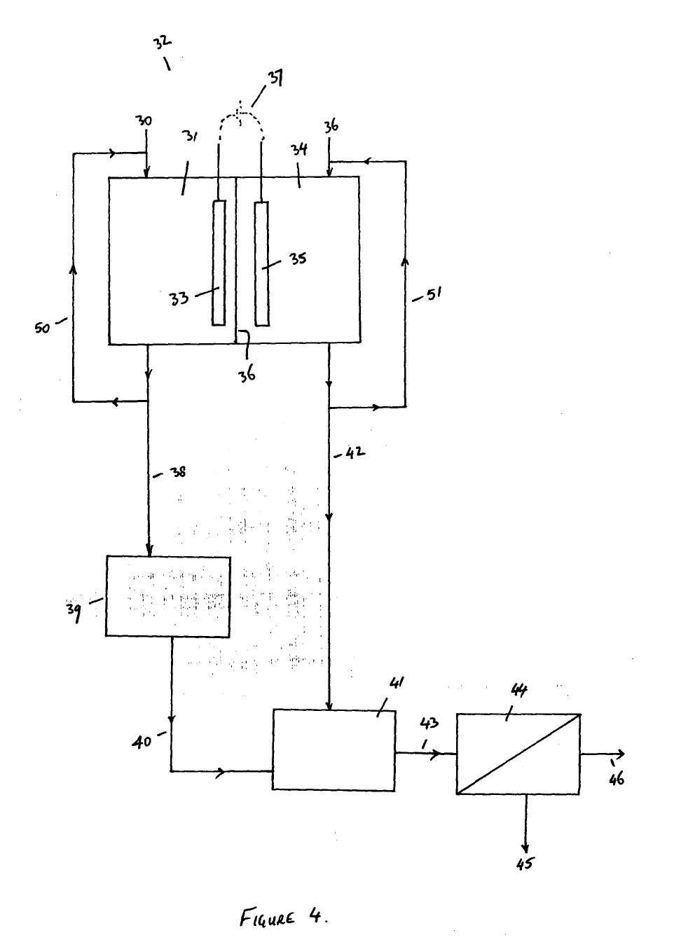

FIG. 3 shows a process flow sheet in which an embodiment of the present invention is implemented in a pulp and paper treatment plant. In FIG. 3, a wastewater stream 1 is fed to an anaerobic digester 2. The wastewater stream 1 is a wastewater stream from a pulp and paper mill and it contains significant amounts of dissolved organic material.

After anaerobic digestion, the treated wastewater stream is fed to a crystallisation reactor 3 in which calcium carbonate and/or other cation salts and hydroxides precipitate due to increased pH. The pH is increased using the alkaline solution coming from the cathode 4

The wastewater stream leaving the crystalliser 3 is then supplied to the anode compartment of a bioelectrochemical apparatus similar to that as shown in FIG. 1. The anode is a biocatalyzed anode. This causes further breakdown of any remaining in/organic material in the wastewater stream. At the same time, water or an aqueous stream 10 is fed to the cathode compartment which houses cathode 4. This results in the generation of a strong caustic stream 11, and this caustic stream can be used as a feed material to the pulp process or, as described above, fed to the precipitation vessel 3 via line 12 to cause precipitation in the precipitation vessel.

The treated wastewater stream leaving the anode compartment may be returned to the anaerobic digester 2 via line 14. Alternatively, it may be sent to waste. As the wastewater stream leaving the anode compartment contains lower levels of contaminants than the wastewater stream leaving the crystalliser 3, disposal costs of the wastewater stream leaving the anode compartment should be lower. As a further benefit, the wastewater stream recycled from the anode compartment to the anaerobic digester 2 is somewhat acidified, thereby reducing the likelihood of unwanted precipitation taking place in the anaerobic digester.

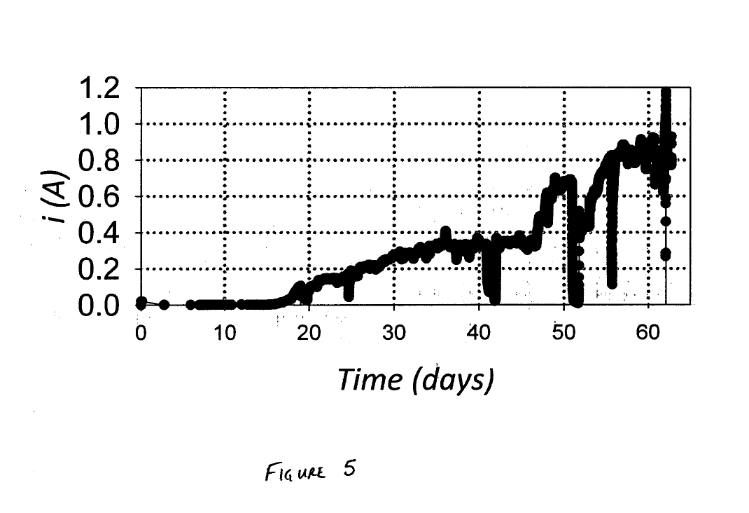

FIG. 4 shows a process flow sheet of a further embodiment of the present invention. In FIG. 4, a wastewater stream 30 is fed to an anode compartment 31 of a bioelectrochemical system 32. Anode compartment 31 contains a biocatalysed anode 33.

The bioelectrochemical system 32 further includes a cathode compartment 34 that contains a cathode 35. An aqueous stream 36 is fed to the cathode compartment 34. An ion permeable membrane 36 separates the anode compartment 31 from the cathode compartment 34. The anode 33 and cathode 34 are electrically connected together by an electrical circuit shown schematically that 37.

In the anode compartment 31, the wastewater organics or inorganics are oxidised by microorganisms. This generates protons and therefore the pH of the wastewater in the anode compartment 31 decreases. Cations from the wastewater, such as sodium or potassium ions, pass through the ion permeable membrane 36 and into the cathode compartment 34. The cathode reactions consume protons and therefore the hydroxyl ion content of the aqueous solution in the cathode compartment 34 increases. This, coupled with the transfer of sodium and/or potassium ions through the ion permeable membrane 36 results in an alkaline stream containing sodium hydroxide and/or potassium hydroxide (and, in all likelihood, other hydroxides as well) being formed in the cathode compartment 34.

The anode effluent leaves the anode compartment 31 via stream 38. The anode effluent is passed to an anaerobic digester 39 for further treatment. As the pH of the wastewater stream that is leaving the anode compartment has been reduced by the reactions taking place in the anode compartment, precipitation of calcium compounds and other compounds is suppressed or minimised in the anaerobic digester (it being appreciated that calcium compounds tend to precipitate at increasing pH). Therefore, utilizing the anode effluent as a feed stream to the anaerobic digester 39 suppresses or minimizes the amount of scaling that is likely to take place in the anaerobic digester 39.

The treated wastewater leaving the anaerobic digester 39 is passed via stream 40 into a precipitator vessel 41. The alkaline stream that is generated in cathode compartment 34 is removed from the cathode compartment via stream 42. In a further embodiment, this alkaline stream can be provided to the precipitation vessel 41 and this causes an increase in the pH of the treated wastewater fed to the vessel 41 via line 40. As a result, calcium compounds and other compounds precipitate in the precipitator vessel 41. Provided the precipitation vessel has no solids separation, the mixture of precipitated solids and liquids can be removed from precipitation vessel 41 via stream 43 and pass to a solid/liquid separator 44. The solids containing stream 45 is sent to waste disposal or to solids recovery. The liquid stream 46 is sent to liquid disposal or to liquid recovery.

As shown in FIG. 4, the effluent leaving the anode compartment 31 may be recycled or circulated back to the anode compartment 31 via a recirculation line 50. Similarly, the alkaline stream leaving the cathode compartment 34 via stream 42 may also be recycled or recirculated back to the cathode compartment 34 via a recirculation line 51. It will be appreciated that the pH of the anode effluent can be adjusted by adjusting the recirculation rate of material flowing through recirculation line 50. Similarly, the pH of the alkaline stream leaving the cathode compartment 34 may be adjusted by adjusting the recirculation rate of material flowing through the recirculation line 51. For example, to increase the pH of the cathode effluent, the amount of recirculation of material through recirculation line 51 can be increased.

Although not shown in FIGS. 1 to 3, the bioelectrochemical systems show in those figures may also be provided with recirculation lines for the anode compartment, the cathode compartment, or both.

### EXAMPLES

Microbial fuel cells (MFCs) have generated considerable interest in the past few years. In a nutshell, MFCs use whole microorganisms as biocatalysts for the oxidation of (in)organic electron donors at an anode. From the anode, electrons gained from the oxidation are conveyed towards a cathode, the latter has a higher potential. As electrons flow from a low to a high potential, a power output is generated. MFCs are nowadays generally referred to as Bioelectrochemical Systems (BESs). One particularly complex issue BESs face is caused by the presence of cations, such as sodium and potassium, in wastewater or other feedstock supplied to the anode. As the concentration of these cations is generally much higher than the proton concentration, they are typically transported to a high extent through the cation exchange membrane of the BES to restore the charge balance between anode and cathode. As a result, the anode tends to acidify due to proton generation in the anode reaction, while the cathode tends to become more alkaline due to proton consumption in the cathode reaction. Diverse strategies have been developed to avoid this. Liu et al. (Liu, H.; Logan, B. E., Electricity generation using an air-cathode single chamber microbial fuel cell in the presence and absence of a proton exchange membrane. Environmental Science & Technology 2004, 38, (14), 4040-4046) omitted the membrane as a whole, thus decreasing the system's ohmic resistance and pH gradient build-up. However, such an approach may cause cross over of anode fuel or cathodic oxygen, causing a decrease of coulombic efficiency. Torres et al. (Tones, C. I.; Lee, H. S.; Rittmann, B. E., Carbonate Species as OH— Carriers for Decreasing the pH Gradient between Cathode and Anode in Biological Fuel Cells. Environmental Science & Technology 2008, 42, (23), 8773-8777) provided carbonate to the cathode of the BES, which in conjunction with an anion exchange membrane between anode and cathode allowed for better balancing of the anode pH. A third strategy by Freguia and coworkers (Freguia, S.; Rabaey, K.; Yuan, Z. G.; Keller, J., Sequential anode-cathode configuration improves cathodic oxygen reduction and effluent quality of microbial fuel cells. Water Research 2008, 42, (6-7), 1387-1396) involves directing the anode effluent to the cathode and vice versa, leading to a reuse of alkalinity—and salts. While attractive for MFC and nitrogen removing BESs, such an approach may impede the formation of valuable chemicals at the cathode due to crossover of organics, oxygen consumption and pollution of the end product.

Rather than battling the pH increase of the cathode, embodiments of the present invention as an advantage to harvest a caustic solution. Indeed, proton consumption in the cathode reaction in combination with the transport of sodium and/or potassium to the cathode generates a caustic solution, comprising of sodium, potassium, and other hydroxides. When a small clean water stream is introduced as the cathode influent, the caustic solution can be harvested. Caustic soda is one of the most widely used chemicals on earth. One of the largest industrial sectors using caustic soda is the pulp and paper industry, which requires this chemical mainly during the pulping and bleaching stage. Other industries such as breweries and dairy plants make extensive use of caustic for cleaning in place of process equipment. All of the aforementioned industries generally have abundant and biodegradable wastewater available, which would allow for the anodic fuel supply to a BES.

Considering the above, experiments were conducted to investigate the potential of BES to produce caustic soda during wastewater treatment. A litre scale reactor that has a lamellar layout was constructed. This BES was operated at high anode throughput to supply high electron densities. At the same time, a limited cathode fluid flow was supplied to obtain a concentrated caustic flow, as used in industry. Parameters of interest were the attainable current, the energy requirement, the organics removal, and the effect of using real wastewater rather than synthetic laboratory feeds.

Methods

A lamellar type reactor was constructed by creating 2 welded cation exchange membrane (CMI-7000, Membranes International Inc.) envelopes (170×200 mm) of 1 cm thickness, and using one sheet membrane for a third anode chamber. The BES had 3 cathode chambers and 3 anode chambers. The membranes were clamped and glued (Bostix, Australia) in a bottom and top groove, surrounding an 8 mm slit. Inside the membrane envelope, on both sides a graphite felt anode was inserted (164×200 mm), clamped to the sides by inserting a corrugated stainless steel mesh (6 mm mesh) (Locker, Australia). As a cathode, either only a corrugated stainless steel mesh (5 mm mesh, 6 mm wire) or this mesh plus two finely woven stainless steel meshes (Locker, Australia) were inserted in the cathode sleeves (164×200 mm). All corrugated meshes were welded on the side to stainless steel rods (5 mm diameter), that connected them to either an anode or a cathode collector plate (316SS, 3 mm thickness). The reactor was then connected to recirculation and feed circuits.

Reactor operation and medium. The inoculum for the initial start up of the reactor was obtained from a lab scale microbial fuel cell, fed with wastewater from the mixing tank of a brewery wastewater treatment plant. The anode was fed with a mixture of two media. The basic medium (initially 6.9 L d⁻¹) contained per liter: 0.1 g NH₄Cl, 0.1 g KH₂PO₄, 0.1 g MgSO₄.7H₂O, 0.02 g CaCl₂.2H₂O and 1 ml of nutrient solution as described previously in Rabaey, K.; Ossieur, W.; Verhaege, M.; Verstraete, W., Continuous microbial fuel cells convert carbohydrates to electricity. Water Science and Technology 2005, 52, (1-2), 515-523. To this medium a concentrate containing sodium acetate (as appropriate for increasing current, starting at 3.93 g L⁻¹) and NaHCO₃ (to ensure neutrality of the incoming concentrate) was added as required to achieve a target current density depending on the status of the reactor. The flow of this concentrate was varied to achieve different loading rates (starting rate was 0.7 L d⁻¹). The anode was also recirculated at 0.7 L h⁻¹, which roughly represents a 1/1 recirculation. The cathode was continuously fed with a salt solution (1 g NaCl L⁻¹), at a rate between 3 and 30 L d⁻¹, and recirculated at this same rate. The operational period can be divided in three runs: (i) first lab based run (ii) second lab based run and (iii) brewery based run. During the first run, the cathode only contained the corrugated mesh as cathode and current collector. The system was operated for 64 days, during which the anode feed was progressively increased by increasing both concentrate concentration and flow. The experiment was terminated shortly after a failure due to gas production. Imperfect sealing between anode and cathode was observed, therefore the reactor was dismantled and rebuilt. At this stage (second lab based run) the finer meshes were inserted into the cathodes to serve as electrode, next to the corrugated mesh as current collector. The system was operated similar to the first run, for 46 days. After this period, the reactor was moved to Fosters brewery (Yatala, Australia) where “mixing tank” wastewater was fed to the reactor. The composition of the incoming wastewater can be seen in Table 1. The influent was, at the end of the experimental phase, mixed in with anaerobic digester effluent to achieve a higher influent pH and gain more alkalinity. The cathode flow was 0.71 L d⁻¹, the anode influent flow was varied between 51 and 702 L d⁻¹.

TABLE 1
Composition of the mixing tank wastewater obtained at the brewery
(average not given due to weekly operational fluctuation).
All concentration values are given in mg L⁻¹.

| | Mixing tank | Anaerobic digester |
|---|---|---|
| pH | 6.1 | 6.8 |
| Alkalinity (as HCO3—) | 242 | 856 |
| Volatile fatty acids | | |
| Acetic acid | 226 | 29 |
| Propionic acid | 307 | 26 |
| i-butyric acid | 3 | 1 |
| n-butyric acid | 125 | 2 |
| i-valeric acid | 3 | 1 |
| n-valeric acid | 120 | 2 |
| hexanoic acid | 6 | <1 |
| Ammonia-N | 101 | 187 |
| Cations | | |
| Calcium | 16 | 15 |
| Sodium | 191 | 187 |
| Potassium | 17 | 15 |
| Anions | | |
| Chloride | 53.2 | 117 |
| Sulfide-S | <1 | <1 |
| Sulfite-S | <1 | <1 |
| Sulfate-S | 5.2 | <1 |
| Thiosulfate-S | <1 | <1 |
| Soluble COD | 2258 | 221 |
| Total COD | 2906 | n.a. |

Electrochemical monitoring and data representation. Measurements and calculations were performed. Potentiostatic measurements and controls were performed using a PAR VMP-3 Potentiostat (Princeton Applied Research, USA) in the laboratory, and with a Bank-IC KP307 potentiostat (Bank-IC, Pohlheim, Germany) in the field. The ohmic resistance of the reactor was measured (in laboratory conditions) using a Frequency Response Analyzer installed on the VMP3 system, at a set anodic potential of −0.300 V vs Ag/AgCl.

Chemical Analyses.

Immediately after sampling, the samples obtained from the anode and cathode compartments were filtered through 0.22 μm sterile filters. The volatile fatty acid (VFA) content was determined by adding 0.9 mL of samples to 0.1 mL of 10% formic acid and subsequently analyse with a gas chromatography method using a polar capillary column (DB-FFAP) at 140° C. and a flame ionization detector at 250° C. The COD measurements were done according to the dichromate method.

To more accurately measure pH values above 13, the samples were diluted 100 times with deionized water.

Results and Discussion

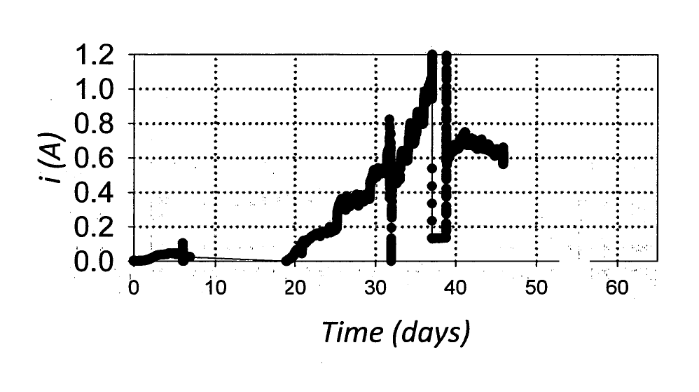

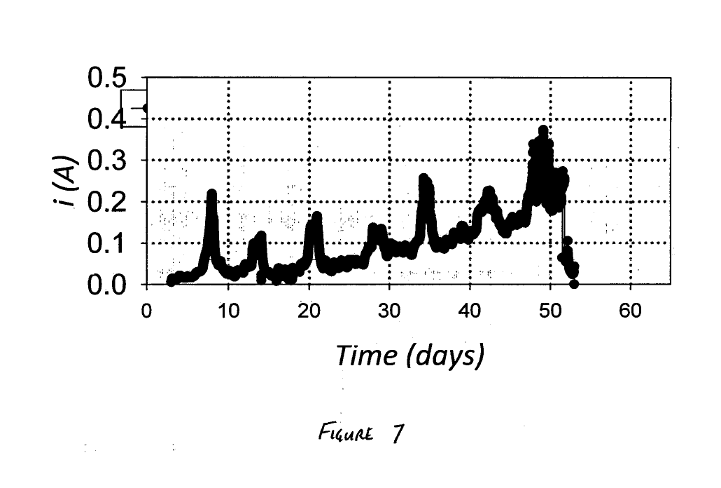

FIG. 5 shows a graph of current vs time for the first laboratory run, FIG. 6 shows a graph of current vs time for the second laboratory run and FIG. 7 shows a graph of current vs time for the brewery run.

First lab run. After start-up (E_{AN}=−0.12 V vs Ag/AgCl), the reactor had a considerable lag phase of 15 days. After this period, the current rapidly increased, on day 19 the anode potential was lowered to E_{AN}=−0.30 V vs Ag/AgCl. During this period, the feed supply was progressively increased to supply up to 9.89 g acetate per day, which was equivalent to a maximum total current of 1.5 A. The pH of the cathode did not reach high values, i.e. the highest value achieved was 10.57. This could either be caused by back diffusion of hydroxyl ions or cross over of some anode fluid to the cathode. Upon inspecting the reactor, a small leak was discovered in the membrane sealing between the anode and the cathode chamber. The reactor was further operated using a pump both for the cathode influent and effluent at equal flow rates to prevent crossover of anode fluis to the cathode. Over time, the current increased to 1.015 A on day 62. At that point, the applied voltage over the BES was 1.77 V, which gives a calculated cathode potential of −2.08 V vs Ag/AgCl. As the cathode was not provided with a separate reference electrode, this value is off by the ohmic resistance of the system.

Second lab run. Cathode stainless steel mesh electrodes were inserted in the cathode compartments, and after reassembly full hydraulic separation between the anode and the cathode was observed. The system was similarly to the first test run progressively supplied with more feed as required for the current generation, over a period of 46 days. Surprisingly, although the anodes used for the first test run were re-used for this second test run, a lag phase of about 18 days was observed before current started to increase. In this second run, a quite consistent increase of the current was obtained, reaching on average 0.977±0.039 A on day 36 (maximum 1.054 A). After reaching these values, the potentiostatic control became unstable, and the anode potential was decreased to E_{AN}=−0.350 V vs Ag/AgCl to restrict current.

The pH of the anode effluent remained quite constant at 7.00±0.35. Based on the influent and effluent concentrations, the acetate removal was 61±20% over the experimental period. The pH of the cathode liquid gradually increased (average 12.5±1.6 after the lag phase) reaching a value of 13.93 on day 42. This corresponds to a 3.4% concentration of hydroxyl as NaOH. On that day, the average current generated was 0.710±0.100 A, which leads to an efficiency of current to caustic conversion of 96% on that day. At the anode, the coulombic efficiency for acetate oxidation was 63% (removal 75%), leading to overall acetate to caustic coulombic efficiency of 61%. As expected, the conductivity of the catholyte significantly increased over time, and exceeded the scale of the conductivity meter available (about 50 mS cm⁻¹) on day 33.

Operation of Lamellar Reactor on Brewery Site.

After 46 days of operation on acetate in the laboratory, the reactor was transferred to a brewery, and initially connected to mixing tank effluent. Mixing tank effluent is a mix of anaerobic digester effluent and fermented liquor—the mixing is performed by plant operators to improve pH of the digester feed. Over a week cycle, the pH and the fatty acid content change considerably, due to different levels of activity at the brewery site. This variation in pH and organics content led to the cyclical behaviour of the current (FIG. 7). To allow for a higher base-line current during the remainder of the week, anaerobic digester effluent (pH˜6.8) was mixed in with the existing feed at a 1/1 ratio. Table 2 shows the data obtained from the experiment operated on the brewery site.

TABLE 2

| | INPUT | | | | | | OUTPUT | | | | | | |
|---|---|---|---|---|---|---|---|---|---|---|---|---|---|
| | E_{AN} | Q_{AN} | Q_{CA} | | | | E_{CA} | E_{BES} | | | I | | |
| Day | (V) | (L/day) | (L/day) | pH_{AN} | pH_{CA} | T^{O} _{AN} | (V) | (V) | pH_{AN} | pH_{CA} | (A) | T^{O} _{AN} | T^{O} _{CA} |
| 0 | −0.2 | 75.8 | | 6.39 | 7 | | −1 | 1.2 | 6.02 | 10.44 | 0.00563 | | |
| 2 | −0.2 | 90.9 | | 6.44 | 7.02 | | −0.579 | 0.78 | 6.14 | 9.76 | 0.031 | | |
| 5 | −0.2 | 0.0 | | 7.33 | 7.02 | | −0.435 | 0.64 | | 10.78 | 0.076 | | |
| 7 | −0.2 | 0.0 | | | 6.98 | | −0.601 | 0.80 | | 10.24 | 0.019 | | |
| 9 | −0.2 | 86.4 | | 6.27 | 7.02 | | 0.2 | | 6.18 | 10.19 | 0.026 | | |
| 12 | −0.1 | 52.8 | | 6.87 | 7.02 | | −1.4 | 1.5 | 6.42 | 11.65 | 0.144 | | |
| 14 | −0.1 | 50.5 | | 6.16 | 7 | | −1 | 1.1 | 5.83 | 11.42 | 0.052 | | |
| 16 | −0.1 | 108.3 | | 6.25 | 7.02 | | −1.15 | 1.25 | 6.11 | 11.68 | 0.065 | | |
| 21 | −0.1 | 157.1 | | 6.43 | 7.02 | 27 | −1.44 | 1.54 | 6.1 | 12.18 | 0.098 | 27.3 | 27 |
| 23 | −0.1 | 320.0 | | 6.28 | 7 | 25.1 | −1.76 | 1.86 | 6.23 | 12.19 | 0.093 | 25.9 | 25.2 |
| 26 | −0.1 | 332.3 | | 7 | 7.02 | 29.2 | −2.3 | 2.4 | 6.98 | 12.29 | 0.221 | 27.9 | 26.7 |
| 28 | −0.1 | 375.7 | | 6.17 | 7.05 | 22.9 | −2.1 | 2.2 | 6.02 | 12.19 | 0.104 | 24 | 24.5 |
| 30 | −0.1 | 454.7 | | 6.15 | 6.96 | 26.9 | −2.98 | 3.08 | 6.16 | 12.22 | 0.145 | 25.5 | 23.5 |
| 33 | −0.1 | 454.7 | | 7.33 | 6.98 | 25.6 | −2.9 | 3 | 7.28 | 12.49 | 0.193 | 24.5 | 24 |
| 35 | −0.1 | 702.4 | | 6.71 | 6.88 | 20.5 | −2.4 | 2.5 | 6.49 | 12.54 | 0.144 | 21.3 | 23.4 |
| 37 | −0.1 | 702.4 | | 6.26 | 6.99 | 27.4 | −3.1 | 3.2 | 6.17 | 11.74 | 0.156 | 27.4 | 24.7 |
| 40 | −0.1 | 702.4 | | 7.02 | 6.87 | 24.9 | −4.47 | 4.57 | 6.92 | 12.03 | 0.29 | 24.9 | 23.1 |
| 42 | −0.1 | 702.4 | | 6.85 | 7.05 | 25.4 | −3.88 | 3.98 | 6.74 | 11.96 | 0.194 | 25.4 | 24.1 |

| | | | | | | | | | | |
|---|---|---|---|---|---|---|---|---|---|---|
| Averages | 6.58 | 6.99 | 25.5 | −1.849 | 2.093 | 6.36 | 11.55 | 0.114 | 25.4 | 24.6 |

The voltage over the BESs increased more than proportionally with the current over time. To investigate whether this was due to scaling at the cathode, the system was stopped and a 1M hydrochloric acid solution was recirculated through the cathode for 5 minutes. Upon restarting the BES, the voltage over the system was considerably lowered for a comparable current, indicating that calcium scaling may have occurred at this high pH. As the incoming flow through the anode is considerable and the calcium content low, the difference between in- and effluent of the anode cannot be measured accurately. Therefore, a calcium balance could not be made for this experiment. Possible scaling in the cathode would furthermore prevent assessing the crossover from the cathode perspective.

Achieving High Current Densities Both in Laboratory and Field Conditions

For the scale of the system deployed here, the obtained current densities notably exceed those reported previously for reactors above the one-litre scale. Key reasons for this are likely (i) improved reactor design, with a focus on current collection, (ii) the use of the anode off gas in the recirculation, (iii) the operation of the BESs using a poised anode potential, and (iv) for real brewery wastewater, the use of anaerobic digester effluent to increase alkalinity

Improved reactor design. The approach here allows to scale up BESs without compromising on the ohmic resistance of the system. Indeed, the ohmic resistance measured was only about 0.1Ω. The key reasons for this is the continued close spacing of anode and cathode, as well as the use of current collectors (stainless steel) to compensate for the low conductivity of the anode. The latter are typically graphite based, and have a conductivity about two orders of magnitude lower than steel.

Use of gas for recirculation. Upon achieving higher currents, the gas production in the system considerably increased. This gas subsequently ended up in the recirculation circuit (1/1 recirculation). Upon entry in the reactor, the gas bubbles cause more turbulence than liquid would. On a short timescale, the effect of these gas bubbles could be verified by observing the fluctuation in current when either gas or liquid was passing through the reactor.

Use of anaerobic digester effluent to control influent pH and supply alkalinity. The influent pH of the mixing tank stream on site fluctuated during the week between 6.1 and 6.5. Taking into account the limited alkalinity available in this wastewater, this severely restricts the current that can be generated per unit wastewater. For the operation of anaerobic digesters, effluent of the digester is very often recirculated back to mix in with preacidified wastewater. This ensures a better influent pH for the digester, and this practice is also done on the brewery site used in this study. We have applied the same strategy for the influent of the BES, by increasing the proportion of digester effluent mixed in with the mixing tank effluent. This allowed us to achieve increasing current production.

This finding has considerable implications for future application of BESs. The acidification BESs represent via the anode may be of use in conjunction with existing digester systems. Moreover, generation of a usable caustic soda stream has been demonstrated.

Those skilled in the art will appreciate that the present invention may be susceptible to variations and modifications other than those specifically described. It will be understood that the present invention encompasses all such variations and modifications that fall within its spirit in scope.

Throughout the specification, the term “comprising” and its grammatical equivalents shall be taken to have an inclusive meaning unless the context indicates otherwise.

The applicant does not concede that the prior art discussed in the specification forms part of the common general knowledge in Australia or elsewhere.

The term “(in)organic” shall be taken to refer to both inorganic material and organic material.

1. A method for treating a wastewater stream containing organic material or inorganic material comprising passing the wastewater stream to an anode or a cathode of a bioelectrochemical system, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, to thereby alter the pH of the wastewater stream to:
a) reduce the pH of the stream passed to the anode to minimise or suppress precipitation of dissolved cations; or
b) increase the pH of the stream passed to the cathode to produce an alkaline stream; or
c) reduce the pH of the stream passed to the anode to produce an acid containing stream.

2. A method for forming an acidic solution or an alkaline solution comprising the steps of providing a bioelectrochemical system having an anode and a cathode, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, feeding an aqueous stream to the anode, feeding an aqueous stream to the cathode, generating an acidic solution at the anode or generating an alkaline solution at the cathode, and recovering the acidic solution or the alkaline solution.

3. A method as claimed in claim 1 wherein the following feed streams are utilised:
i) a wastewater stream is fed to the anode and a wastewater stream is fed to the cathode;
ii) a wastewater stream is fed to the anode and water or an aqueous stream is fed to the cathode;
iii) a wastewater stream is fed to the cathode and water or an aqueous solution is fed to the anode; or
iv) water or an aqueous solution is fed both to the anode and the cathode.

4. A method for treating a wastewater stream containing organic and/or inorganic material comprising passing the wastewater stream to an anode or a cathode of a bioelectrochemical system, said bioelectrochemical system having an anode at which one or more reactions are biocatalysed by microorganisms or a cathode at which one or more reactions are biocatalysed by microorganisms or both an anode and a cathode at which one or more reactions are biocatalysed by microorganisms, to thereby:
a) reduce the pH of the stream passed to the anode to minimise or suppress precipitation of dissolved cations; or
b) increase the pH of the stream passed to the cathode to produce an alkaline stream; or
c) reduce the pH of the stream passed to the anode to produce an acid containing stream.

5. A method for producing an alkaline aqueous stream comprising the steps of:
providing a bioelectrochemical system comprising an anode compartment having a biocatalysed anode and a cathode compartment having a cathode, the anode compartment and the cathode compartment being separated by an ion permeable membrane, the anode and the cathode being electrically connected to each other;
feeding a wastewater stream to the anode compartment such that organic material and/or inorganic material in the wastewater stream is oxidised;
feeding an aqueous stream to the cathode compartment,
wherein the ion permeable membrane allows cations to pass therethrough but limits the flow of anions therethrough and wherein an alkaline stream is generated in the cathode compartment, and
removing the alkaline aqueous stream from the cathode compartment.

6. A method as claimed in claim 5 wherein the alkaline stream is generated by consumption of protons at the cathode.

7. A method as claimed in claim 5 wherein the ion selective membrane comprises a cation selective membrane that selectively allows monovalent cations to pass therethrough and the alkaline aqueous stream removed from the cathode compartment comprises a solution of sodium hydroxide or potassium hydroxide or both.

8. A method as claimed in claim 5 wherein the pH of the alkaline aqueous stream leaving the cathode compartment is at least 11, more preferably greater than 12.5, even more preferably up to 14.

9. A method as claimed in claim 1 wherein the wastewater stream is passed to a biocatalysed anode of the bioelectrochemical system such that oxidation of the organic material in the wastewater stream occurs to reduce the quantity or concentration of the organics in the wastewater stream and protons (H⁺ ions) are also formed to cause a decrease in the pH of the wastewater stream, wherein the pH of the wastewater stream decreases to a level at which precipitation of cations (particularly calcium ions or magnesium ions or struvite ions) or precipitation reactions is minimised or suppressed.

10. A method is claimed in claim 9 wherein the wastewater stream is treated such that the pH decreases to 7 or below.

11. A method as claimed in claim 1 wherein the cathode is biocatalyzed by electrochemically active microorganisms and the biological activity of the electrochemically active microorganisms at the cathode results in the increase in pH of the stream supplied to the cathode.

12. A method as claimed in claim 11 wherein the pH of the stream removed from the cathode is from about 8 to 8.5.

13. A method as claimed in claim 1 wherein the aqueous stream that is passed to the cathode comprises a salt solution or a brine or seawater that contains dissolved cations including one or more selected from sodium, potassium, calcium and magnesium

14. A method as claimed in claim 1 wherein the pH of the stream that is fed to the anode is reduced to produce an acid containing stream having a pH of below 4, more preferably below 2, even more preferably below 1, and the stream that is supplied to the anode comprises water or an aqueous stream, and the bioelectrochemical system includes a membrane that is selectively permeable to anions, and the method further comprises recovering the acid containing stream for storage or for use.

15. A method as claimed in claim 1 wherein the aqueous stream entering the anode is wastewater from a paper factory or paper recycling plant or paper and pulp plant containing calcium ions and the wastewater is acidified in the anode and an alkaline solution is generated at the cathode, said alkaline solution being added to the wastewater to precipitate calcium ions.

16. A method as claimed in claim 15 wherein the wastewater has passed through an anaerobic digester and the effluent of the anaerobic digester is passed to the anode.

17. A method as claimed in claim 16 wherein the effluent from the anaerobic digester goes through a reactor vessel in which calcium ions are precipitated, an effluent of the reactor vessel goes to the anode where it is acidified, part or all of an effluent from the anode goes directly or indirectly back to the anaerobic digester, and in the cathode an alkaline stream is generated which is supplied to the reactor vessel in which calcium ions are precipitated.

18. A method as claimed in claim 1 wherein wastewater from a brewing or brewery tank cleaning process is used as a feed stream to the anode, while at the cathode an alkaline solution is created.

19. A method as claimed in claim 1 wherein the anode is biocatalysed and a wastewater stream flows past the anode such that the pH of the wastewater stream is reduced and an anode effluent comprising a treated wastewater stream of reduced pH is fed to an anaerobic digester, wherein the reduced pH of the anode effluent fed to the anaerobic digester suppresses or minimises precipitation in the anaerobic digester.

20. A method as claimed in claim 19 wherein an effluent stream leaving the cathode comprises an alkaline stream and the alkaline stream is added to an effluent stream from the anaerobic digester to cause precipitation of compounds from the anaerobic digester effluent.

21. A method as claimed in claim 20 wherein the alkaline stream and the effluent stream from the anaerobic digester are mixed in a separate vessel.
